(19) United States
(12) Patent Application Publication
(10) Pub. No.: US 2025/0307039 A1
(43) Pub. Date: Oct. 2, 2025

(54) OPTIMIZED GPU KERNEL APPLICATION MANAGEMENT

(71) Applicant: Advanced Micro Devices, Inc., Santa Clara, CA (US)

(72) Inventors: Manu Rastogi, Casselberry, FL (US); Alexander Fuad Ashkar, Winter Park, FL (US); Luca Gallo, Torre Annunziata (IT)

(21) Appl. No.: 18/618,553

(22) Filed: Mar. 27, 2024

(51) Int. Cl. G06F 9/54; G06F 9/48

(52) U.S. Cl. CPC G06F 9/544; G06F 9/4881; G06F 2209/543; G06F 2209/548

(57) ABSTRACT

An apparatus and method for efficiently performing work assignments for a processing circuit. In various implementations, a computing system includes a processing circuit and a memory. The memory stores kernels corresponding to function calls of a parallel data application. The processing circuit includes a command processing circuit with a scheduler and multiple execution pipes. Each of the multiple execution pipes includes multiple work queues, each storing one of multiple assigned kernels from the multiple kernels stored in memory. The kernel mode driver sends an indication to the scheduler when a kernel is ready to be assigned to a work queue. Rather than serially performing corresponding mapping operations, the scheduler sends the mapping operations to the multiple execution pipes. When a work queue stores a completed kernel, the scheduler or other control circuitry sends a context save operation to an idle execution pipe, rather than to the scheduler.

### BACKGROUND

### Description of the Relevant Art

Many different types of computing systems include vector processing circuits or single-instruction, multiple-data (SIMD) circuits. Vector processing circuits, or SIMD circuits, include multiple parallel lanes of execution. Tasks can be executed in parallel on these types of parallel data processing circuits to increase the throughput of the computing system. The memory stores at least the instructions (or translated commands) of a parallel data application. The instructions are placed in kernels, each corresponding to a function call in the parallel data application. The parallel data processing circuit includes a command processing circuit with a scheduler and multiple execution pipeline (or “pipes”). Each of the multiple execution pipes includes multiple work queues, each storing one of multiple assigned kernels from the multiple kernels stored in memory. The scheduler of the command processing circuit assigns kernels to work queues via mapping operations, and performs context save operations when removing kernels from work queues. The scheduler performs the mapping operations and the context save operations in a serial manner. In addition, the corresponding execution pipeline stalls execution of each of its work queues during the context save operation of a single work queue.

In view of the above, efficient methods and apparatuses for efficiently performing work assignments for a processing circuit are desired.

### BRIEF DESCRIPTION OF THE DRAWINGS

FIG. 1 is a generalized diagram of a computing system that efficiently performs work assignments for a processing circuit.

FIG. 2 is a generalized diagram of an apparatus that efficiently performs work assignments for a processing circuit.

FIG. 3 is a generalized diagram of kernel scheduling.

FIG. 4 is a generalized diagram of kernel scheduling that efficiently performs work assignments for a processing circuit.

FIG. 5 is a generalized diagram of kernel mapping that efficiently performs work assignments for a processing circuit.

FIG. 6 is a generalized diagram of a method for efficiently performing work assignments for a processing circuit.

FIG. 7 is a generalized diagram of a method for efficiently performing work assignments for a processing circuit.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for efficiently performing work assignments for a processing circuit are contemplated. In various implementations, a computing system includes a parallel data processing circuit and a memory. The parallel data processing circuit uses a parallel data microarchitecture such as a single instruction multiple data (SIMD) parallel microarchitecture. The memory stores at least the instructions (or translated commands) of a parallel data application. The instructions are placed in kernels, each corresponding to a function call in the parallel data application. The parallel data processing circuit includes a command processing circuit with a scheduler and multiple execution pipes. Each of the multiple execution pipes comprise circuitry including multiple work queues, each storing one of multiple assigned kernels from the multiple kernels stored in memory.

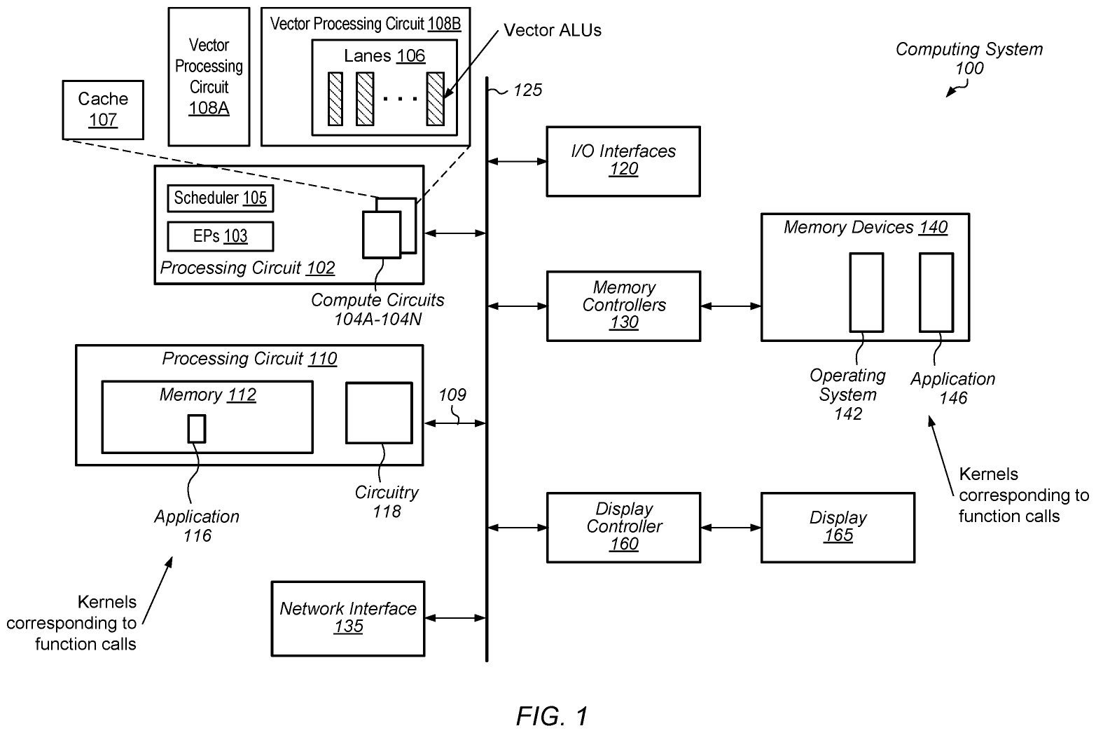

When a kernel is assigned to a work queue, a mapping operation is performed. The kernel mode driver sends commands and indications to the scheduler of the command processing circuit, which performs kernel mapping operations when new kernels are ready to be executed. In some implementations, the kernel mapping operations (or mapping operations) assign a memory queue descriptor (MQD) of the kernel stored in system memory (a ring buffer in system memory) to a work queue of an execution pipe identified by a hardware queue descriptor (HQD). Other identifiers besides the MQD of the kernel and the HQD of the work queue are possible and contemplated in other implementations to assign (map) the kernel to the work queue. Rather than sequentially perform the individual mapping operations, the scheduler or other control circuitry of the command processing circuit sends the mapping operations to the multiple execution pipes to perform the mapping operations concurrently with respect to one another. When a work queue stores a kernel that has been completed by functional circuit blocks of the parallel data processing circuit, the scheduler receives a command specifying removing the kernel from the work queue of a first execution pipe of the multiple execution pipes. In various implementations, control circuitry checks statuses of the multiple execution pipes. The control circuitry can be placed in the scheduler, in each of the multiple execution pipes, such as the first execution pipe, or another location. The control circuitry assigns the command to a second execution pipe of the multiple execution pipes, responsive to the second execution pipe is idle. Further details of these techniques to efficiently perform work assignments for a processing circuit are provided in the following description of FIGS. 1-8.

Turning now to FIG. 1, a generalized diagram is shown of a computing system 100 that efficiently performs work assignments for a processing circuit. In an implementation, computing system 100 includes at least processing circuits 102 and 110, input/output (I/O) interfaces 120, bus 125, network interface 135, memory controllers 130, memory devices 140, display controller 160, and display 165. In other implementations, computing system 100 includes other components and/or computing system 100 is arranged differently. For example, power management circuitry, and phased locked loops (PLLs) or other clock generating circuitry are not shown for ease of illustration. In various implementations, the components of the computing system 100 are on the same die such as a system-on-a-chip (SOC). In other implementations, the components are individual dies in a system-in-package (SiP) or a multi-chip module (MCM). A variety of computing devices use the computing system 100 such as a desktop computer, a laptop computer, a server computer, a tablet computer, a smartphone, a gaming device, a smartwatch, and so on.

Processing circuits 102 and 110 are representative of any number of processing circuits which are included in computing system 100. In an implementation, processing circuit 110 is a general-purpose central processing unit (CPU). In one implementation, processing circuit 102 is a parallel data processing circuit with a highly parallel data microarchitecture, such as a GPU. The processing circuit 102 can be a discrete device, such as a dedicated GPU (dGPU), or the processing circuit 102 can be integrated (an iGPU) in the same package as another processing circuit. Other parallel data processing circuits that can be included in computing system 100 include digital signal processing circuits (DSPs), field programmable gate arrays (FPGAs), application specific integrated circuits (ASICs), and so forth.

In various implementations, processing circuit 102 includes multiple, replicated compute circuits 104A-104N, each including similar circuitry and components such as the vector processing circuits 108A-108B, the cache 107, and other hardware resources (not shown) such as fixed function circuit blocks. Cache 107 can be used as a shared last-level cache in a compute circuit. Vector processing circuit 108A includes replicated circuitry of the circuitry of the vector processing circuit 108B. Although two vector processing circuits are shown, in other implementations, another number of vector processing circuits is used based on design requirements. As shown, vector processing circuit 108B includes multiple, parallel computational lanes 106. These parallel computational lanes 106 operate in lockstep. In various implementations, the data flow within each of the lanes 106 is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration.

The high parallelism offered by the hardware of the compute circuits 104A-104N is used for real-time data processing. Examples of real-time data processing are rendering multiple pixels, image blending, pixel shading, vertex shading, and geometry shading. In such cases, each of the data items of a wavefront is a pixel of an image. The compute circuits 104A-104N can also be used to execute other threads that require operating simultaneously with a relatively high number of different data elements (or data items). Examples of these threads are threads for scientific, medical, finance and encryption/decryption computations.

In some implementations, the application 146 stored on the memory devices 140 and its copy (application 116) stored on the memory 112 are a highly parallel data application that includes particular function calls using an API to allow the developer to insert a request in the highly parallel data application for launching wavefronts of a kernel (function call). In an implementation, this kernel launch request is a C++ object, and it is converted by circuitry 118 of the processing circuit 110 to a command. Processing circuit 110 stores the commands in a ring buffer in a system memory provided by memory devices 140. A parallel data processing circuit, such as processing circuit 102, reads the commands from the ring buffer. In various implementations, the hardware of scheduler 105 and execution pipelines (or “pipes”) 103 (EPs 103) are included in a command processing circuit (command processor) of processing circuit 102.

A command indicating to launch a kernel is referred to herein as a “kernel.” A kernel mode driver of operating system 142 sends an indication to the command processing circuit of processing circuit 102 to retrieve these kernels. Each of the multiple execution pipes 103 includes multiple work queues, each storing one of multiple assigned kernels from the multiple kernels stored in system memory provided by memory devices 140. Each of the execution pipes 103 can also be referred to as an asynchronous compute engine (ACE) or an asynchronous compute circuit. In an implementation, asynchronous compute circuits process the tasks of a function call (kernel) stored as architected queuing language (AQL) packets in an assigned work queue, and does the processing out of order, when possible, to allow processing circuit 102 to improve utilization of its computing resources.

In an implementation, processing circuit 102 has eight execution pipes 103, each with eight work queues. Therefore, processing circuit 102 can have 64 separate function calls (kernels) for the vector processing circuits 108A-108B assigned simultaneously and ready for dispatch. Processing circuit 102 can have another number of separate function calls (kernels) for the DMA circuit and another number of separate function calls (kernels) for the fixed-function circuits assigned simultaneously and ready for dispatch. Therefore, processing circuit 102 can support processing more than 64 separate function calls (kernels). Asynchronous compute circuits (execution pipes 103) save context state information locally as the asynchronous compute circuits process the tasks of the assigned kernels. With the use of execution pipes 103 (and other execution pipes for DMA circuit and fixed-function circuits), less-intensive computing tasks can be processed in an overlapped manner with higher intensive computing tasks (e.g., pixel processing) to fill gaps in execution where the computing resources of processing circuit 102 would otherwise be idle.

When a kernel is assigned to a work queue of one of the execution pipes 103, a mapping operation is performed. In an implementation, the kernel mapping operations (or mapping operations) assign a memory queue descriptor (MQD) of the kernel stored in system memory (a ring buffer in system memory) to a work queue of an execution pipe (one of EPs 103) identified by a hardware queue descriptor (HQD). Other identifiers besides the MQD of the kernel and the HQD of the work queue are possible and contemplated in other implementations to assign (map) the kernel to the work queue.

In some implementations, processing circuit 102 includes execution pipes 103 for the vector processing circuits 108A-108B, one or more execution pipes (not shown) for a direct memory access (DMA) circuit (not shown), and one or more execution pipes (not shown) for fixed-function circuits (not shown). The direct memory access (DMA) circuit accesses memory, such as system memory provided by memory devices 140, independent of another processing circuit or core of a processing circuit. In some implementations, the fixed-function circuits include one or more of a video decoder for encoded movies and other videos, a display controller, and so forth. In an implementation, the vector processing circuits 108A-108B are used for real-time data processing, whereas the fixed-function circuits are used for non-real-time data processing. Examples of real-time data processing are rendering multiple pixels, image blending, pixel shading, vertex shading, and geometry shading. Examples of non-real-time data processing are multimedia playback, such as a video decoding for encoded audio/video streams, image scaling, image rotating, color space conversion, and power up initialization. In various implementations, execution pipes 103 operate concurrently with respect to one another and with respect to the execution pipes of the DMA circuit and the fixed-function circuits.

The kernel mode driver sends commands and indications to scheduler 105 of the command processing circuit, which performs kernel mapping operations when new kernels are ready to be executed. Rather than sequentially perform the individual mapping operations, the scheduler 105 or other control circuitry of the command processing circuit sends the mapping operations to the multiple execution pipes 103 to perform the mapping operations concurrently with respect to one another. When a work queue stores a kernel that has been completed by functional circuit blocks of processing circuit 102, the scheduler 105 receives a command specifying removing the kernel from the work queue of a first execution pipe of the multiple execution pipes 103. In various implementations, control circuitry checks the status of the multiple execution pipes 103. The control circuitry can be placed in scheduler 105, in each of the multiple execution pipes 103, or another location. The control circuitry assigns the command to a second execution pipe of the multiple execution pipes 103, responsive to the second execution pipe is idle.

Memory 112 represents a local hierarchical cache memory subsystem. Memory 112 stores source data, intermediate results data, results data, and copies of data and instructions stored in memory devices 140. Processing circuit 110 is coupled to bus 125 via interface 109. Processing circuit 110 receives, via interface 109, copies of various data and instructions, such as the operating system 142, one or more device drivers, one or more applications such as application 146, and/or other data and instructions. The processing circuit 110 retrieves a copy of the application 146 from the memory devices 140, and the processing circuit 110 stores this copy as application 116 in memory 112.

In some implementations, computing system 100 utilizes a communication fabric (“fabric”), rather than the bus 125, for transferring requests, responses, and messages between the processing circuits 102 and 110, the I/O interfaces 120, the memory controllers 130, the network interface 135, and the display controller 160. When messages include requests for obtaining targeted data, the circuitry of interfaces within the components of computing system 100 translates target addresses of requested data. In some implementations, the bus 125, or a fabric, includes circuitry for supporting communication, data transmission, network protocols, address formats, interface signals and synchronous/asynchronous clock domain usage for routing data.

Memory controllers 130 are representative of any number and type of memory controllers accessible by processing circuits 102 and 110. While memory controllers 130 are shown as being separate from processing circuits 102 and 110, it should be understood that this merely represents one possible implementation. In other implementations, one of memory controllers 130 is embedded within one or more of processing circuits 102 and 110 or it is located on the same semiconductor die as one or more of processing circuits 102 and 110. Memory controllers 130 are coupled to any number and type of memory devices 140.

Memory devices 140 are representative of any number and type of memory devices. For example, the type of memory in memory devices 140 includes Dynamic Random Access Memory (DRAM), Static Random Access Memory (SRAM), NAND Flash memory, NOR flash memory, Ferroelectric Random Access Memory (FeRAM), or otherwise. Memory devices 140 store at least instructions of an operating system 142, one or more device drivers, and application 146. In some implementations, application 441 is a highly parallel data application such as a video graphics application, a shader application, or other. Copies of these instructions can be stored in a memory or cache device local to processing circuit 110 and/or processing circuit 102.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, and so forth. Network interface 135 receives and sends network messages across a network.

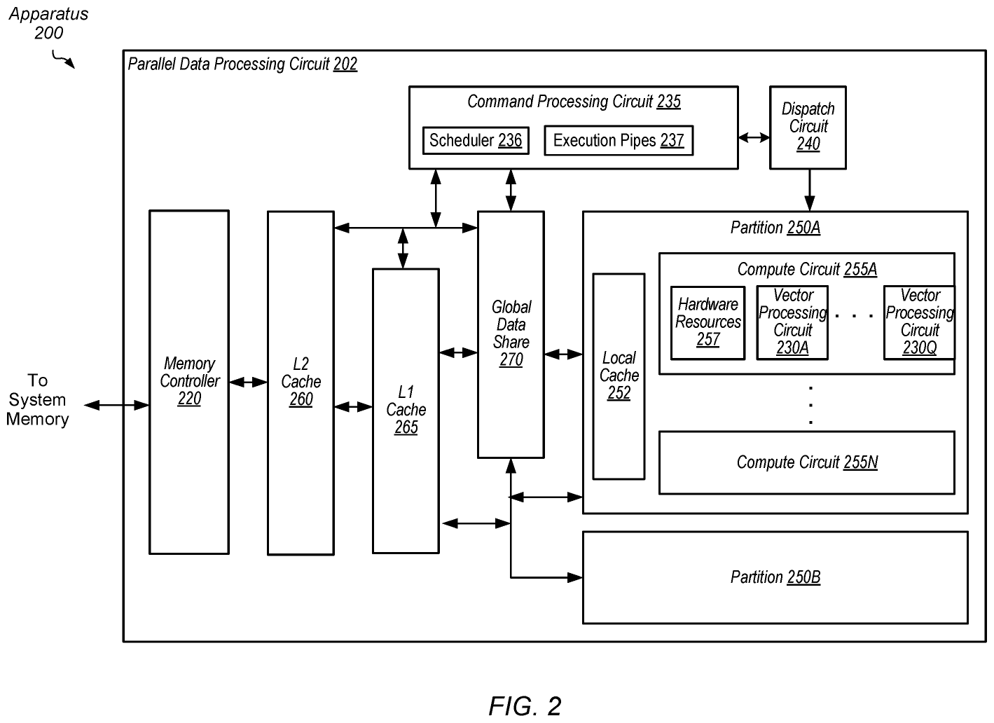

Turning now to FIG. 2, a block diagram is shown of an apparatus 200 that efficiently processes multiplication and accumulate operations for matrices in applications. In one implementation, apparatus 200 includes parallel data processing circuit 202 with an interface to system memory. In an implementation, parallel data processing circuit 202 is a graphics processing unit (GPU). In various implementations, apparatus 200 executes any of various types of highly parallel data applications. As part of executing an application, a host CPU (not shown) launches kernels to be executed by the parallel data processing circuit 202. The command processing circuit 235 receives kernels from the host CPU and determines when dispatch circuit 240 dispatches wavefronts of these kernels to the compute circuits 255A-255N.

Multiple processes of a highly parallel data application provide work to be executed on compute circuits 255A-255N. The parallel data processing circuit 202 includes at least the command processing circuit (or command processor) 235, dispatch circuit 240, compute circuits 255A-255N, memory controller 220, global data share 270, shared level one (L1) cache 362, and level two (L2) cache 260. It should be understood that the components and connections shown for the parallel data processing circuit 202 are merely representative of one type processing circuit and does not preclude the use of other types of processing circuits for implementing the techniques presented herein. The apparatus 200 also includes other components which are not shown to avoid obscuring the figure. In other implementations, the parallel data processing circuit 202 includes other components, omits one or more of the illustrated components, has multiple instances of a component even if only one instance is shown in the apparatus 200, and/or is organized in other suitable manners. Also, each connection shown in apparatus 200 is representative of any number of connections between components. Additionally, other connections can exist between components even if these connections are not explicitly shown in apparatus 200.

In an implementation, the memory controller 220 directly communicates with each of the partitions 250A-250B and includes circuitry for supporting communication protocols and queues for storing requests and responses. Threads within wavefronts executing on compute circuits 255A-255N read data from and write data to the cache 252, vector general-purpose registers, scalar general-purpose registers, and when present, the global data share 270, the shared L1 cache 265, and the L2 cache 260. When present, it is noted that the shared L1 cache 265 can include separate structures for data and instruction caches. It is also noted that global data share 270, shared L1 cache 265, L2 cache 260, memory controller 220, system memory, and cache 252 can collectively be referred to herein as a “cache memory subsystem”.

In various implementations, the circuitry of partition 250B is a replicated instantiation of the circuitry of partition 250A. In some implementations, each of the partitions 250A-250B is a chiplet. As used herein, a “chiplet” is also referred to as an “intellectual property block” (or IP block). However, a “chiplet” is a semiconductor die (or die) fabricated separately from other dies, and then interconnected with these other dies in a single integrated circuit in the MCM. On a single silicon wafer, only multiple chiplets are fabricated as multiple instantiated copies of particular integrated circuitry, rather than fabricated with other functional blocks that do not use an instantiated copy of the particular integrated circuitry. For example, the chiplets are not fabricated on a silicon wafer with various other functional blocks and processors on a larger semiconductor die such as an SoC. A first silicon wafer (or first wafer) is fabricated with multiple instantiated copies of integrated circuitry a first chiplet, and this first wafer is diced using laser cutting techniques to separate the multiple copies of the first chiplet. A second silicon wafer (or second wafer) is fabricated with multiple instantiated copies of integrated circuitry of a second chiplet, and this second wafer is diced using laser cutting techniques to separate the multiple copies of the second chiplet.

In an implementation, cache 252 represents a last level shared cache structure such as a local level-two (L2) cache within partition 250A. Additionally, each of the multiple compute circuits 255A-255N includes vector processing circuits 230A-230Q, each with circuitry of multiple parallel computational lanes of simultaneous execution. These parallel computational lanes operate in lockstep. In various implementations, the data flow within each of the lanes is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration. Each of the ALUs within a given row across the lanes includes the same circuitry and functionality, and operates on the same instruction, but different data, such as a different data item, associated with a different thread.

In addition to the vector processing circuits 230A-230Q, compute circuit 255A also includes the hardware resources 257. The hardware resources 257 include at least an assigned number of vector general-purpose registers (VGPRs) per thread, an assigned number of scalar general-purpose registers (SGPRs) per wavefront, and an assigned data storage space of a local data store per workgroup. Each of compute circuits 255A-255N receives wavefronts from dispatch circuit 240 and stores the received wavefronts in a corresponding local dispatch circuit (not shown). A local scheduler within compute circuits 255A-255N schedules these wavefronts to be dispatched from the local dispatch circuits to the vector processing circuits 230A-230Q. Cache 252 can be the last level shared cache structure of the partition 250A.

The hardware of scheduler 236 and execution pipes 237 are included in command processing circuit 235. In various implementations, scheduler 236 has the same functionality as scheduler 105 and execution pipes 237 have the same functionality as execution pipes 103 (of FIG. 1). The kernel mode driver sends commands and indications to scheduler 236 of command processing circuit 235, which performs kernel mapping operations when new kernels are ready to be executed. Rather than sequentially perform the individual mapping operations, the scheduler 236 or other control circuitry of the command processing circuit 235 sends the mapping operations to the multiple execution pipes 237 to perform the mapping operations concurrently with respect to one another.

When a work queue stores a kernel that has been completed by functional circuit blocks of partitions 250A-250B, the scheduler 236 receives a command specifying removing the kernel from the work queue of a first execution pipe of the multiple execution pipes 237. In various implementations, control circuitry checks the status of the multiple execution pipes 237. The control circuitry can be placed in the scheduler 236, in each of the multiple execution pipes 237, or another location. The control circuitry assigns the command to a second execution pipe of the multiple execution pipes 237, responsive to the second execution pipe is idle.

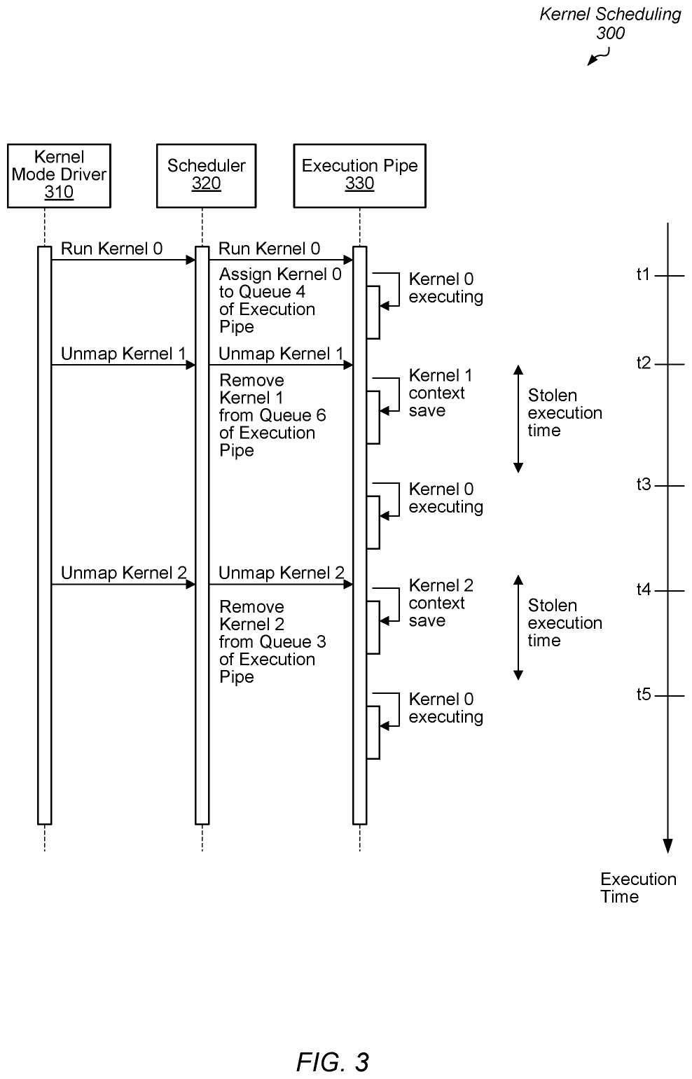

Referring to FIG. 3, a generalized block diagram is shown of kernel scheduling 300 that performs context save operations for kernels. In the illustrated implementation, a kernel mode driver 310 sends command packets to a scheduler 320, which assigns the command packets to a work queue of multiple work queues of one of multiple execution pipes such as execution pipe 330. In various implementations, execution pipe 330 has the same functionality as execution pipes 103 (of FIG. 1) and execution pipes 237 (of FIG. 2). When a kernel is assigned to a work queue of one of the execution pipes, such as execution pipe 330, a mapping operation is performed. In an implementation, the kernel mapping operations (or mapping operations) assign a memory queue descriptor (MQD) of the kernel stored in system memory (a ring buffer in system memory) to a work queue of an execution pipe identified by a hardware queue descriptor (HQD). Other identifiers besides the MQD of the kernel and the HQD of the work queue are possible and contemplated in other implementations to assign (map) the kernel to the work queue.

Although a single execution pipe is shown, such as execution pipe 330, a command processing circuit of a parallel data processing circuit includes any number of execution pipes based on design requirements. Similar to execution pipes 103 (of FIG. 1) and execution pipes 237 (of FIG. 2), execution pipe 330 parses incoming commands and dispatches tasks to compute circuits of the parallel data processing circuit. In an implementation, execution pipe 330 has eight work queues. In other implementations, execution pipe 330 has another number of work queues based on design requirements. As shown, at point in time t1 (or time t1), the kernel mode driver 310 sends a command packet indicating “Run Kernel 0.” Scheduler 320 assigns Kernel 0 to work queue 4 (or queue 4 or queue slot 4) of execution pipe 330. Execution pipe 330 begins executing the commands of kernel 0 after assignment by scheduler 320. Although not shown, execution pipe 330 is also executing other Kernels on other, separate work queues of its multiple work queues. For example, execution pipe 330 is also executing the commands of Kernel 1 on work queue 6 of its multiple work queues and executing the commands of Kernel 2 on separate work queue 3 of its multiple work queues.

At time t2, the kernel mode driver 310 sends a command packet indicating “Unmap Kernel 1.” For example, Kernel 1 has completed its assigned task and Kernel 1 is now idle on work queue 6 of execution pipe 330. Scheduler 320 assigns the unmapping operations to execution pipe 330. Execution pipe 330 begins executing performing context save operations for Kernel 1 after assignment by scheduler 320. The context save operations for Kernel 1 removes Kernel 1 from queue 6 of execution pipe 330. The mappings (assignments) between the MQD of the kernel and the HQD of the work queue (or other identifiers) are also removed. However, to perform the context save operations for Kernel 1, execution pipe 330 stalls execution of other kernels assigned to its multiple work queues. For example, at least Kernel 0 assigned to work queue 4 is stalled. At time t3, execution pipe 330 completes performing the context save operations for Kernel 1 and execution pipe 330 returns to execution other kernels assigned to its multiple work queues. For example, execution pipe 330 returns to executing at least Kernel 0 assigned to work queue 4.

At time t4, the kernel mode driver 310 sends a command packet indicating “Unmap Kernel 2.” For example, Kernel 2 has completed its assigned task and Kernel 2 is now idle on work queue 3 of execution pipe 330. Scheduler 320 assigns the unmapping operations to execution pipe 330. Execution pipe 330 begins executing performing context save operations for Kernel 2 after assignment by scheduler 320. The context save operations for Kernel 2 removes Kernel 2 from queue 3 of execution pipe 330. However, to perform the context save operations for Kernel 2, execution pipe 330 stalls execution of other kernels assigned to its multiple work queues. For example, at least Kernel 0 is stalled. At time t5, execution pipe 330 completes performing the context save operations for Kernel 2 and execution pipe 330 returns to execution other kernels assigned to its multiple work queues. For example, execution pipe 330 returns to executing at least Kernel 0 assigned to work queue 4.

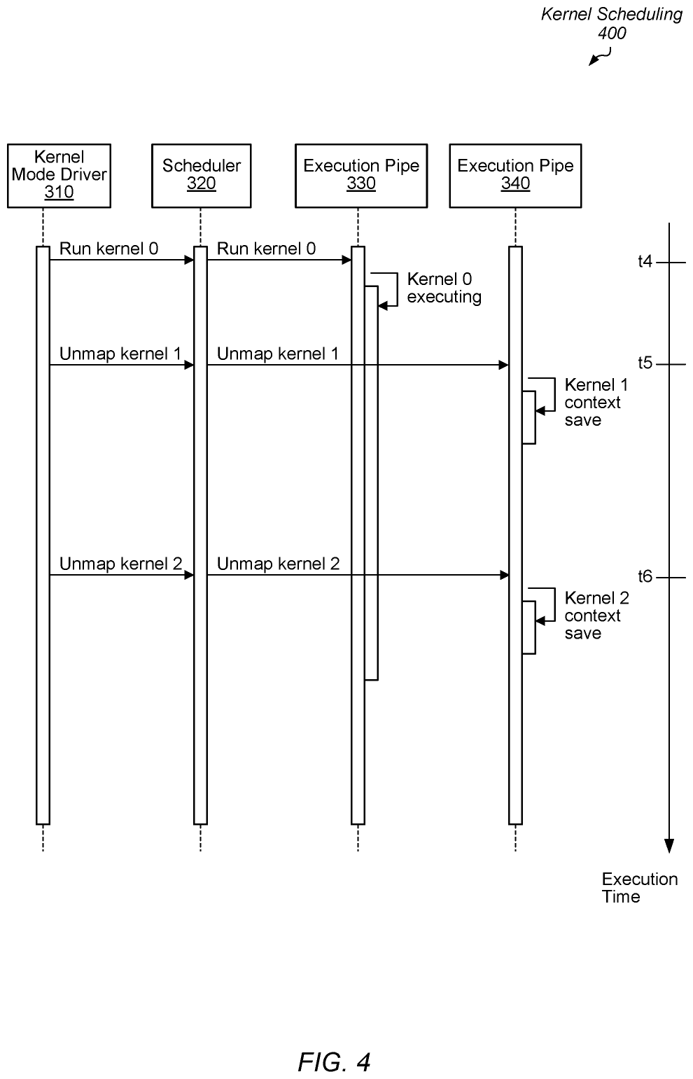

Turning now to FIG. 4, a generalized block diagram is shown of a command processor 400 that efficiently performs context save operations for kernels. Components and circuitry described earlier are numbered identically. The kernel mode driver 310 sends command packets to scheduler 320, which assigns the command packets to a work queue of multiple work queues of one of multiple execution pipes such as execution pipe 330 and execution pipe 440. Although two execution pipes are shown, a command processing circuit of a parallel data processing circuit includes any number of execution pipes based on design requirements. As shown, at time t4, the kernel mode driver 310 sends a command packet indicating “Run Kernel 0.” Scheduler 320 assigns Kernel 0 to work queue 4 (or queue 4 or queue slot 4) of execution pipe 330. Execution pipe 330 begins executing the commands of kernel 0 after assignment by scheduler 320. Although not shown, execution pipe 330 is also executing other Kernels on other, separate work queues of its multiple work queues. For example, execution pipe 330 is also executing the commands of Kernel 1 on work queue 6 of its multiple work queues and executing the commands of Kernel 2 on separate work queue 3 of its multiple work queues.

At time t5, the kernel mode driver 310 sends a command packet indicating “Unmap Kernel 1.” For example, Kernel 1 has completed its assigned task and Kernel 1 is now idle on work queue 6 of execution pipe 330. Scheduler 320 assigns the unmapping operations to execution pipe 330. In various implementations, execution pipe 330 checks the status of its work queues and finds that queue 4 is executing Kernel 0 and queue 3 is executing Kernel 2. Since at least one queue of its multiple queues is active by executing an assigned kernel, execution pipe 330 inspects the status of other execution pipes such as at least execution pipe 440. In an implementation, execution pipe 330 sends an interrupt to other execution pipes such as at least execution pipe 440 requesting a status update. In another implementation, execution pipe 330 performs a read operation targeting configuration and status registers of the other execution pipes such as at least execution pipe 440. An execution pipe has a status of being idle when all of its work queues are unassigned to any kernels.

When execution pipe 330 receives an indication specifying that another execution pipe is idle such as execution pipe 440, execution pipe 330 assigns the unmapping operations for Kernel 1 on queue 6 of execution pipe 330 to execution pipe 440. Execution pipe 440 performs the unmapping operations for Kernel 1 on queue 6 of execution pipe 330 while execution pipe 330 continues executing kernels on its work queues. For example, execution pipe 330 continues execution without interruption of at least Kernel 0 on queue 4. Execution pipe 440 performs read operations of configuration and status registers to access context state information of Kernel 1 on queue 6 of execution pipe 330. Removing the context state information also removes Kernel 1 from queue 6 of execution pipe 330, which allows queue 6 to return to being unassigned and available. At time t6, the kernel mode driver 310 sends a command packet indicating “Unmap Kernel 2.” For example, Kernel 2 has completed its assigned task and Kernel 2 is now idle on work queue 3 of execution pipe 330. Scheduler 320 assigns the unmapping operations to execution pipe 330. Execution pipe 330 repeats the above steps to find an idle execution pipe to save the context state information of Kernel 2, which allows execution pipe 330 to continue executing at least Kernel 0 on queue 4 without stalling.

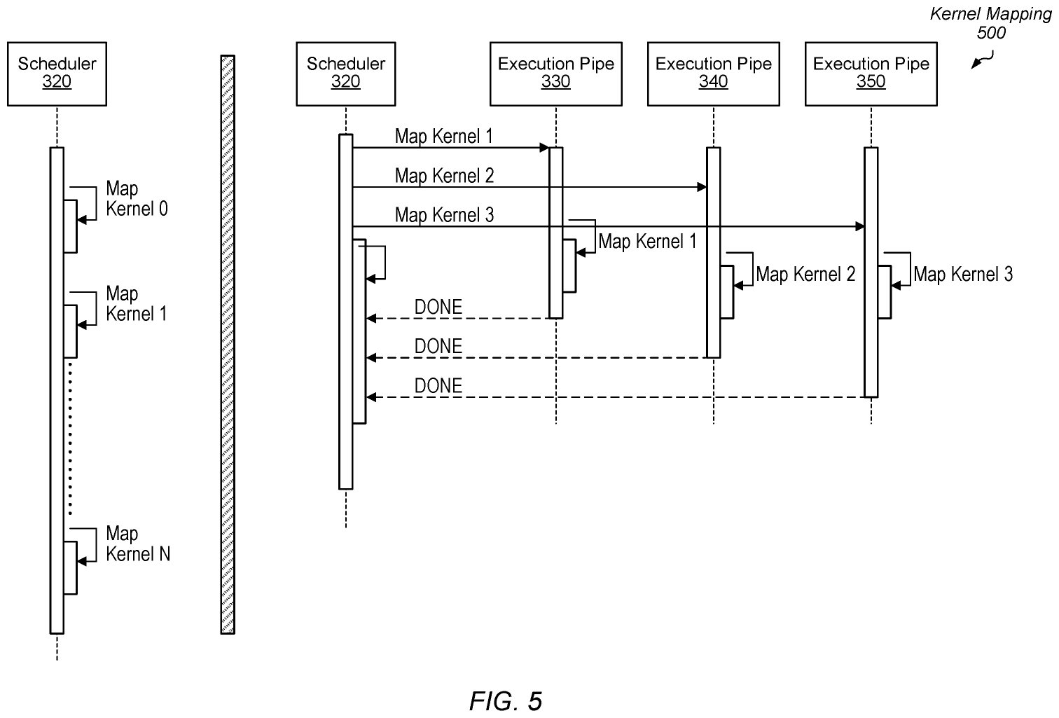

Referring to FIG. 5, a generalized block diagram is shown of a command processor 500 that efficiently performs mapping operations for kernels. Components and circuitry described earlier are numbered identically. The kernel mode driver (not shown) sends commands and indications to scheduler 320, which performs kernel mapping operations when new kernels (new command packets) are ready to be executed. The kernel mapping operations (or mapping operations) assign a memory queue descriptor (MQD) of the kernel stored in system memory (a ring buffer in system memory) to a work queue of an execution pipe identified by a hardware queue descriptor (HQD). On the left side of FIG. 5, scheduler 320 performs the mapping operations serially. In an implementation, the compute circuit of the parallel data processing circuit has four execution pipes with each execution pipe using eight work queues. Therefore, serially performing the mapping operations for 32 kernels by scheduler 320 consumes 32 microseconds when each mapping operation consumes 1 microsecond.

On the right side of FIG. 5, the kernel mode driver (not shown) sends commands and indications to scheduler 320 to perform kernel mapping operations when new kernels (new command packets) are ready to be executed. Rather than sequentially perform the individual mapping operations, scheduler 320 sends the mapping operations to the execution pipes 330, 340 and 350. Although three execution pipes are shown, in other implementations, another number of execution pipes is used based on design requirements. Each of the execution pipes 330, 340 and 350 performs the individual mapping operations assigned to it. In an implementation, the compute circuit of the parallel data processing circuit has four execution pipes with each execution pipe using eight work queues. Scheduler 320 serially sends four individual mapping operations to the four execution pipes. Each of the mapping operations includes an indication of eight kernels to assign to eight work queues of a corresponding execution pipe. When each mapping operation consumes 1 microsecond, only two microseconds are consumed to perform mapping operations for 32 kernels. Scheduler 320 consumes 1 microsecond to send mapping operations to multiple execution pipes, such as execution pipes 330, 340 and 350, and each of the multiple execution pipes consumes 1 microsecond to perform the mapping operations in parallel for its corresponding eight work queues. Each of the multiple execution pipes, such as execution pipes 330, 340 and 350, sends an indication specifying completion (“DONE”) to scheduler 320 when the mapping operations are completed.

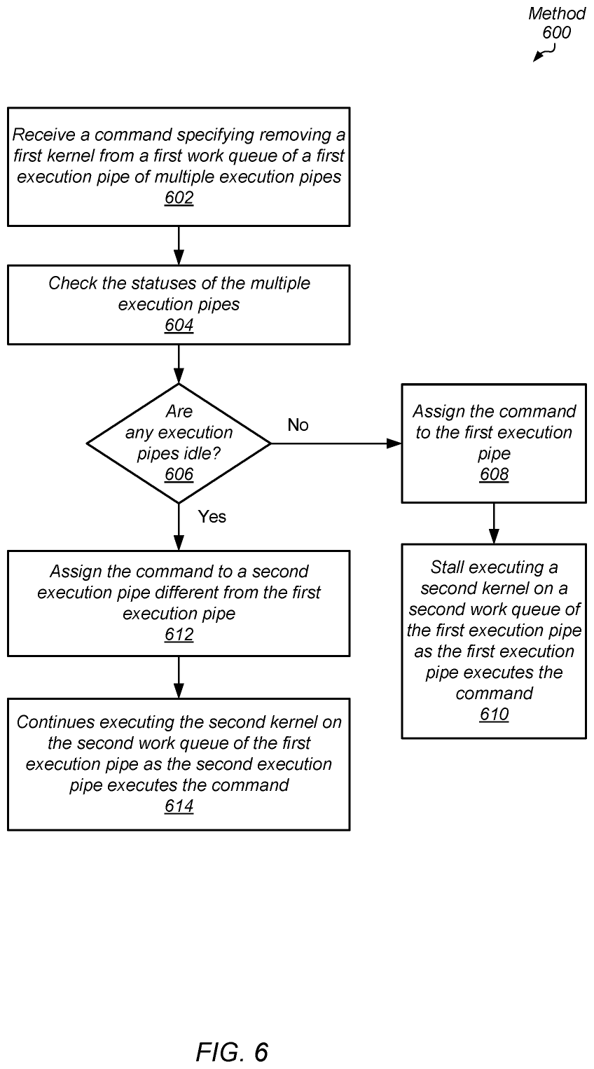

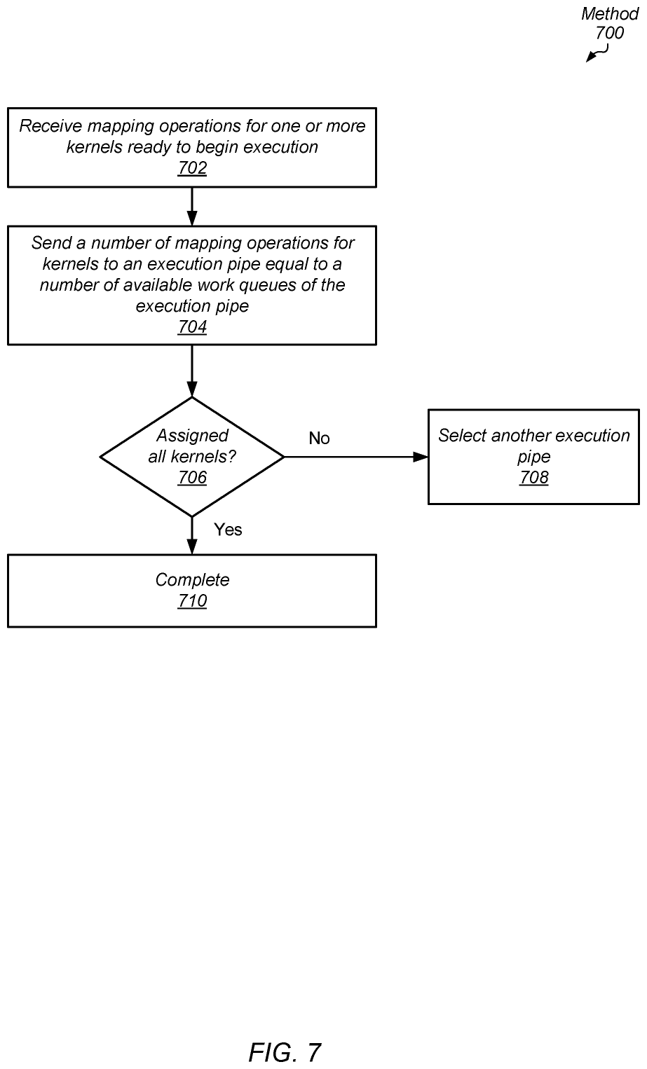

Referring to FIG. 6, a generalized diagram is shown of a method 600 for efficiently performing context save operations for kernels. For purposes of discussion, the steps in this implementation (as well as FIG. 7) are shown in sequential order. However, in other implementations some steps occur in a different order than shown, some steps are performed concurrently, some steps are combined with other steps, and some steps are absent.

A scheduler of a command processing circuit of a parallel data processing circuit receives a command from a kernel mode driver or operating system specifying removing a first kernel from a first work queue of a first execution pipe of multiple execution pipes (block 602). Circuitry of the command processing circuit checks the statuses of the multiple execution pipes (block 604). If the circuitry does not find any idle execution pipes (“no” branch of the conditional block 606), then the circuitry assigns the command to the first execution pipe (block 608). The first execution pipe stalls executing a second kernel on a second work queue of the first execution pipe as the first execution pipe executes the command (block 610).

If the circuitry finds an idle execution pipe (“yes” branch of the conditional block 606), then the circuitry assigns the command to a second execution pipe different from the first execution pipe (block 612). The first execution pipe continues executing the second kernel on the second work queue of the first execution pipe as the second execution pipe executes the command (block 614).

Turning now to FIG. 7, a generalized diagram is shown of a method 700 for efficiently performing mapping operations for kernels. A command processing circuit of a parallel data processing circuit receives mapping operations for one or more kernels ready to begin execution (block 702). The kernels correspond to function calls of a parallel data application. Control circuitry of the command processing circuit sends a number of mapping operations for kernels to an execution pipe equal to a number of available work queues of the execution pipe (block 704). If not all of the kernels are assigned (“no” branch of the conditional block 706), then the control circuitry selects another execution pipe (block 708). If all of the kernels are assigned (“yes” branch of the conditional block 706), then the assignments have competed (block 710).

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVER, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
a plurality of execution pipes, each comprising one or more work queues configured to store an assigned kernel; and
circuitry configured to:
receive a first command to remove a first kernel from a first work queue of a first execution pipe of the plurality of execution pipes; and
assign the first command to a second execution pipe of the plurality of execution pipes, responsive to an indication that the second execution pipe is idle.

2. The apparatus as recited in claim 1, wherein the circuitry is further configured to generate the indication responsive to receiving a status specifying each of the one or more work queues of the second execution pipe is unassigned.

3. The apparatus as recited in claim 2, wherein the circuitry is further configured to generate one or more of an interrupt operation and read operation to access configuration registers of the second execution pipe.

4. The apparatus as recited in claim 1, wherein the first execution pipe continues executing a second kernel on a second work queue as the second execution pipe executes the first command.

5. The apparatus as recited in claim 4, wherein the circuitry is further configured to retrieve context state information of the first kernel from the first work queue of the first execution pipe, responsive to one or more of an interrupt and read operations from the second execution pipe.

6. The apparatus as recited in claim 4, wherein responsive to receiving an indication of a mapping operation for a third kernel, the circuitry is further configured to assign the mapping operation to a third execution pipe of the plurality of execution pipes in place of a scheduler.

7. The apparatus as recited in in claim 6, wherein the circuitry is further configured to send an indication of completion to the scheduler, responsive to the third execution pipe has completed mapping the third kernel to a work queue of the third execution pipe.

8. A method, comprising:
receiving, by circuitry of a vector processing circuit, a first command specifying removing a first kernel from a first work queue of a first execution pipe of a plurality of execution pipes, each comprising one or more work queues configured to store an assigned kernel; and
assigning, by the circuitry, the first command to a second execution pipe of the plurality of execution pipes, responsive to an indication that the second execution pipe is idle.

9. The method as recited in claim 8, further comprising generating the indication responsive to receiving a status specifying each of the one or more work queues of the second execution pipe is unassigned.

10. The method as recited in claim 8, further comprising generating one or more of an interrupt and read operations to access configuration registers of the second execution pipe.

11. The method as recited in claim 8, further comprising continuing executing, by the first execution pipe, a second kernel on a second work queue as the second execution pipe executes the first command.

12. The method as recited in claim 11, further comprising retrieving context state information of the first kernel from the first work queue of the first execution pipe, responsive to one or more of an interrupt and read operations from the second execution pipe.

13. The method as recited in claim 11, wherein responsive to receiving an indication of a mapping operation for a third kernel, the method further comprises assigning the mapping operation to a third execution pipe of the plurality of execution pipes in place of a scheduler.

14. The method as recited in claim 13, further comprising sending an indication of completion to the scheduler, responsive to the third execution pipe has completed mapping the third kernel to a work queue of the third execution pipe.

15. A computing system comprising:
a memory configured to store a plurality of kernels; and
a vector processing circuit comprising:
a plurality of execution pipes, each comprising one or more work queues configured to store an assigned kernel of the plurality of kernels; and
circuitry; and
wherein the circuitry is configured to:
receive a first command specifying removing a first kernel of the plurality of kernels from a first work queue of a first execution pipe of the plurality of execution pipes;
assign the first command to a second execution pipe of the plurality of execution pipes, responsive to an indication that the second execution pipe is idle.

16. The computing system as recited in claim 15, wherein the circuitry is further configured to generate the indication responsive to receiving a status specifying each of the one or more work queues of the second execution pipe is unassigned.

17. The computing system as recited in claim 16, wherein the circuitry is further configured to generate one or more of an interrupt and read operations to access configuration registers of the second execution pipe.

18. The computing system as recited in claim 15, wherein the first execution pipe continues executing a second kernel on a second work queue as the second execution pipe executes the first command.

19. The computing system as recited in claim 18, wherein the circuitry is further configured to retrieve context state information of the first kernel from the first work queue of the first execution pipe, responsive to one or more of an interrupt and read operations from the second execution pipe.

20. The computing system as recited in claim 18, wherein responsive to receiving an indication of a mapping operation for a third kernel, the circuitry is further configured to assign the mapping operation to a third execution pipe of the plurality of execution pipes in place of a scheduler.
